(19) United States
(12) Patent Application Publication
(10) Pub. No.: US 2012/0105916 A1
(43) Pub. Date: May 3, 2012

(54) PRINTING CONTROL APPARATUS AND METHOD WITH DOCUMENT SECURITY FUNCTION

(75) Inventors: Seung Wan LEE, Suwon-si (KR); Jun Young Choi, Suwon-si (KR); Jae Young Soh, Hwaseong-si (KR)

(73) Assignee: Samsung Electronics Co., Ltd, Suwon-si (KR)

(21) Appl. No.: 13/231,023

(22) Filed: Sep. 13, 2011

(30) Foreign Application Priority Data
Sep. 20, 2010 (KR) 10-2010-0092599

(51) Int. Cl. G06K 15/02

(52) U.S. Cl. 358/3.28; 358/1.14

(57) ABSTRACT

A printing control apparatus includes a user interface driver to provide a security preview setup screen such that security preview options for each object are selected when a call signal is transmitted from a graphic device interface according to a print request signal input from an application program and a previewer to divide objects through the security preview setup screen and to secure a corresponding one of the objects when the security preview options are set so as to perform preview. A preview screen upon which security options for each object are set is displayed, thereby preventing malicious use and easily achieving security intended by a user.

### CROSS-REFERENCE TO RELATED APPLICATIONS

This application claims the benefit of priority under 35 U.S.C. §119 from Korean Patent Application No. 10-2010-0092599, filed on Sep. 20, 2010 in the Korean Intellectual Property Office, the disclosure of which is incorporated herein by reference in its entirety.

### BACKGROUND OF THE INVENTION

1. Field of the Invention

Embodiments of the present general inventive concept relate to a printing control apparatus and method that secure a document displayed on a preview screen.

2. Description of the Related Art

Generally, to form an image and obtain printed matter, print data are created by a host apparatus and transmitted to an image forming apparatus to print the print data. The image forming apparatus converts the received print data into a format in which the print data will be printed and prints the print data having such a format.

When print data prepared by the host apparatus is actually printed by the image forming apparatus, an image of the print data displayed by the host apparatus is generally different from an image printed by the image forming apparatus. This is because a method of displaying the image on a display unit of the host apparatus is not identical to a method of printing the image at the image forming apparatus.

For this reason, the host apparatus and the image forming apparatus provide an image obtained through a forecast before actual printing of print data, i.e., a preview image.

Meanwhile, in recent years, information security has been emphasized due to damage caused by information leakages, and much research has been conducted into methods of maintaining information security of printed documents. When a preview image is displayed before printing, a preview function may be provided to maintain security on some or all of the documents selected by users.

### SUMMARY OF THE INVENTION

It is an aspect of the present general inventive concept to provide a printing control apparatus and method with a document security function through which a document is displayed while security is maintained for each object during preview.

Additional aspects of the general inventive concept will be set forth in the description which follows and will be obvious from the description, or may be learned by practice of the general inventive concept.

Features and/or utilities of the present general inventive concept may be realized by a printing control apparatus with a document security function includes a user interface driver to provide a security preview setup screen such that security preview options for each object are selected when a call signal is transmitted from a graphic device interface according to a print request signal input from an application program and a previewer to divide objects through the security preview setup screen and to secure a corresponding one of the objects when the security preview options are set so as to perform preview.

The previewer may include an object map creation unit to record and store an object attribute of each position of an enhanced meta file converted from an original file such that preview is performed before printing.

The previewer may further include a security preview execution unit to confirm the object attribute of each position of the enhanced meta file recorded by the object map creation unit when a security operation is set to be performed with respect to one or more of the objects through the security preview setup screen and to secure and display the object upon which the security operation is set to be performed.

The previewer may further include a security authentication unit to communicate with a server or perform security authentication using information stored in a host computer upon reception of an ID (identification)/PW (password) or PIN (personal identification number) for security authentication.

The previewer may further include a security output unit to create and send a command to print data to which security options are applied to a print processor or to create and send a command to print data to which security options are not applied to the print processor according to security authentication information transmitted from the security authentication unit.

The previewer may simultaneously display the security preview setup screen and a preview screen such that preview security options are edited during execution of the preview.

Each of the objects may include at least one selected from a group consisting of text, a vector, and an image.

Features and/or utilities of the present general inventive concept may also be realized by a control method of a printing control apparatus with a document security function includes converting an original file into an enhanced meta file to perform preview before printing and spooling the enhanced meta file, loading the spooled enhanced meta file to classify and record an object attribute of each position of the enhanced meta file, converting the enhanced meta file into preview data that are displayed on a display, and determining whether security preview options for each object have been selected upon execution of the preview and securing the corresponding objects to perform preview upon determining that the security preview options for each object have been selected.

The control method may further include performing security authentication of a user requesting preview and performing security preview upon which a security operation is performed or general preview upon which a security operation is not performed according to a result of the security authentication.

The control method may further include transmitting preview data upon which the security operation has been performed or preview data upon which the security operation has not been performed to a printer according to a result of the security authentication.

The control method may further include transmitting preview data upon which the security operation has been performed or preview data upon which the security operation has not been performed to a printer connected to the printing control apparatus such that the printer performs security authentication to output a document.

Performing security authentication of the user requesting the preview may include communicating with a server or performing security authentication using information stored in a host computer upon reception of an ID/PW or PIN for the security authentication.

Classifying and recording the object attribute of each position of the enhanced meta file may include classifying and recording object attributes based on types of items recorded in the enhanced meta file.

Features and/or utilities of the present general inventive concept may also be realized by a printing control apparatus including a previewer to determine whether a security option has been set to obstruct at least one type of object in a preview image, and to generate the preview image including a security feature to obstruct the at least one type of object when it is determined that the security option has been set.

The previewer may determine whether the security option has been set with respect to each separate one of at least text, graphics, and pictures of a document to be previewed.

The security feature may include at least one of a watermark, a blackout block, a replacement image, and a blurring effect.

The printing control apparatus may include a security authentication unit to determine whether predetermined authentication information has been received, to generate the preview image including the security feature when it is determined that the predetermined authentication information has not been received, and to generate the preview image to exclude the security feature when it is determined that the predetermined authentication information has been received.

The previewer may include a print processing unit to receive image data and an initial print command and to generate preview image data and a display processing unit to receive the preview image data and to generate display data based on the preview image data to transmit to a display device to display the display data. The print processing unit may generate an EMF spool file and loads the EMF spool file to generate the preview image data.

Features and/or utilities of the present general inventive concept may also be realized by a printing system, including a printer to print an image on a printing medium, a printing control apparatus to generate print data and to transmit the print data to the printer to print the image, and a display to receive preview image data from the printing control apparatus corresponding to the image to be printed by the printer, and to display a preview image based on the preview image data. The printing control apparatus may include a previewer to determine whether a security option has been set to obstruct at least one type of object in the preview image data, and to generate the preview image data including a security feature to obstruct the at least one type of object when it is determined that the security option has been set.

The display may display the preview image having the at least one type of object obstructed when the previewer determines that the security option has been set.

The previewer may include a security authentication unit to determine whether predetermined authentication information has been received, to generate the preview image data including the security feature when it is determined that the predetermined authentication information has not been received, and to generate the preview image data to exclude the security feature when it is determined that the predetermined authentication information has been received.

The printing system may include an authentication server to store predetermined authentication information. The printing control apparatus may receive input authentication information from a user and may transmit the input authentication information to the authentication server. The authentication server may compare the input authentication information to the predetermined authentication information and may transmit an authentication confirmation to the authentication unit of the previewer when the input authentication corresponds to the predetermined authentication information.

Features and/or utilities of the present general inventive concept may also be realized by a method of securely providing data in a printing apparatus, the method including receiving print data corresponding to a request to print data, determining whether a security option has been set to obstruct at least one type of object in a preview image corresponding to print data to be printed, and generating the preview image including a security feature to obstruct the at least one type of object when it is determined that the security option has been set.

The request to print data may be received from an application running on a computing apparatus, and the print data may correspond to a document generated by the application.

Determining whether the security option has been set may include determining whether the security option has been set with respect to each separate one of at least text, graphics, and pictures of a document to be previewed.

The security feature may include at least one of a watermark, a blackout block, a replacement image, and a blurring effect.

Determining whether a security option has been set may include determining whether predetermined authentication information has been received and generating the preview image including the security feature when it is determined that the predetermined authentication information has not been received, and generating the preview image to exclude the security feature when it is determined that the predetermined authentication information has been received.

Features and/or utilities of the present general inventive concept may also be realized by a computer-readable medium having stored thereon a code to execute a method, the method including receiving print data corresponding to a request to print data, determining whether a security option has been set to obstruct at least one type of object in a preview image corresponding to print data to be printed, and generating the preview image including a security feature to obstruct the at least one type of object when it is determined that the security option has been set.

### BRIEF DESCRIPTION OF THE DRAWINGS

These and/or other aspects of the general inventive concept will become apparent and more readily appreciated from the following description of the embodiments, taken in conjunction with the accompanying drawings of which:

FIG. 1 is a software block diagram of a printing control apparatus according to an embodiment of the present general inventive concept;

FIG. 2 is a view illustrating a security preview setup screen of the printing control apparatus according to an embodiment of the present general inventive concept;

FIG. 3 is a schematic block diagram illustrating security preview and printing operations of the printing control apparatus according to an embodiment of the present general inventive concept;

FIGS. 4A and 4B illustrate an editing screen for secure preview setup and security output setup, when a preview screen is displayed, of the printing control apparatus according to the embodiment of an present general inventive concept;

FIGS. 5A to 5C are views illustrating preview data, to which security options are applied, of the printing control apparatus according to an embodiment of the present general inventive concept;

FIG. 6 is a view illustrating a printing operation based on user security authentication of the printing control apparatus according to an embodiment of the present general inventive concept;

FIG. 7 is a flow chart illustrating a security preview execution method of the printing control apparatus according to an embodiment of the present general inventive concept;

FIG. 8 is a flow chart illustrating a process of editing security options, during preview execution, of the printing control apparatus according to an embodiment of the present general inventive concept;

FIG. 9 is a flow chart illustrating a process of transmitting print data to a printer, after preview execution, of the printing control apparatus according to an embodiment of the present general inventive concept;

FIG. 10 is a flow chart illustrating a process of transmitting print data to a printer, after preview execution, of the printing control apparatus according to an embodiment of the present general inventive concept;

FIG. 11 is a flow chart illustrating an administrator level and display of preview data based on the administrator level, during preview execution, of the printing control apparatus according to an embodiment of the present general inventive concept;

FIG. 12 illustrates a printing control apparatus according to an embodiment of the present general inventive concept; and

FIG. 13 illustrates a preview generating unit according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout.

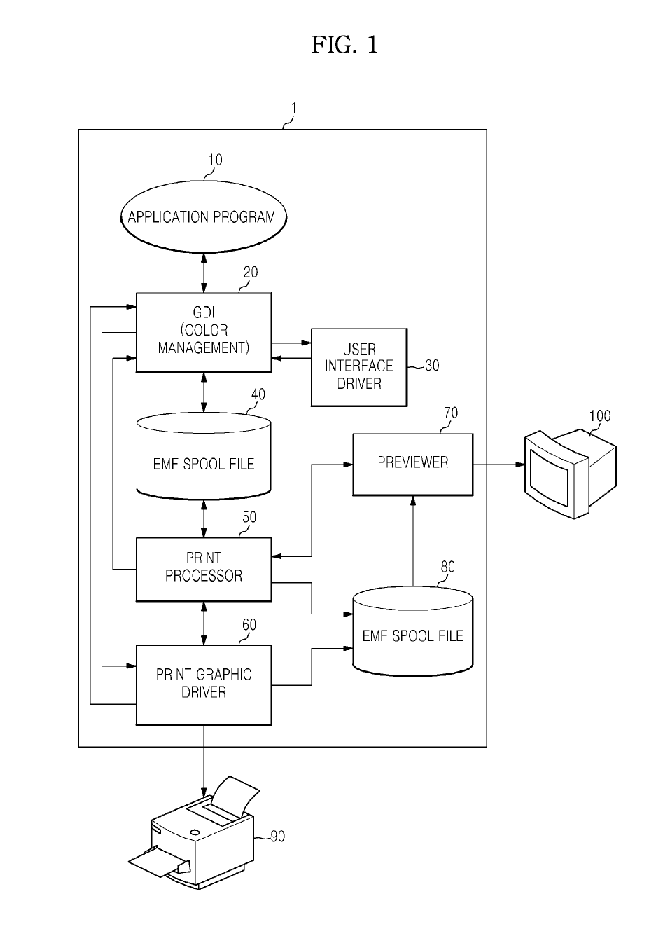

FIG. 1 is a software block diagram of a printing control apparatus 1 according to an embodiment of the present general inventive concept.

The printing control apparatus 1 includes an application program 10, a graphic device interface (GDI) 20, a user interface driver 30, enhanced meta file (EMF) spool files 40 and 80, a print processor 50, a printer graphic driver 60, and a previewer 70.

The printing control apparatus 1 creates print data, which are transmitted to an image forming apparatus 90. The image forming apparatus 90 has a printing function. In this embodiment, a host computer having a print driver is used as an example of the printing control apparatus 1, and a printer is used as an example of the image forming apparatus 90. The host computer may be a personal computer, such as a tower including a CPU, memory, and other logic circuitry to control input and output operations and to run one or more application programs

The application program 10 is provided in a memory, such as a hard disk drive, of the host computer 1. The application program 10 may be a word processor which allows users to write documents including text, graphics, and/or photographs or pictures, and which reads documents written by users or already prepared documents to print the documents via a printer connected to the printing control apparatus 1. Other examples of application programs may include a database program, a web browser, and a communication program. When the application program 10 prints a prepared document, the application program 10 sends the document and a print request signal input through a user interface to the GDI 20.

The GDI 20 draws a graphic object on a screen. When the operating system is MS Windows, GDI 20 may be a component of MS Windows to perform graphic functions such as line drawing and color management. The GDI 20 may be a dynamic link library (DLL) providing a function that the application program uses to output graphs to a display, a printer, or other apparatuses and architecture related thereto. The GDI 20 may draw a straight line, a curved line, a polygon, text, and a bitmap image.

According to the print request signal input from the application program 10, the GDI 20 calls the user interface driver 30 to provide a printing condition setup screen. The printing condition setup screen is an interface to allow a user to set printing conditions, such as paper size, print range, print quality, and number of copies. The printing condition setup screen is displayed on a display 100.

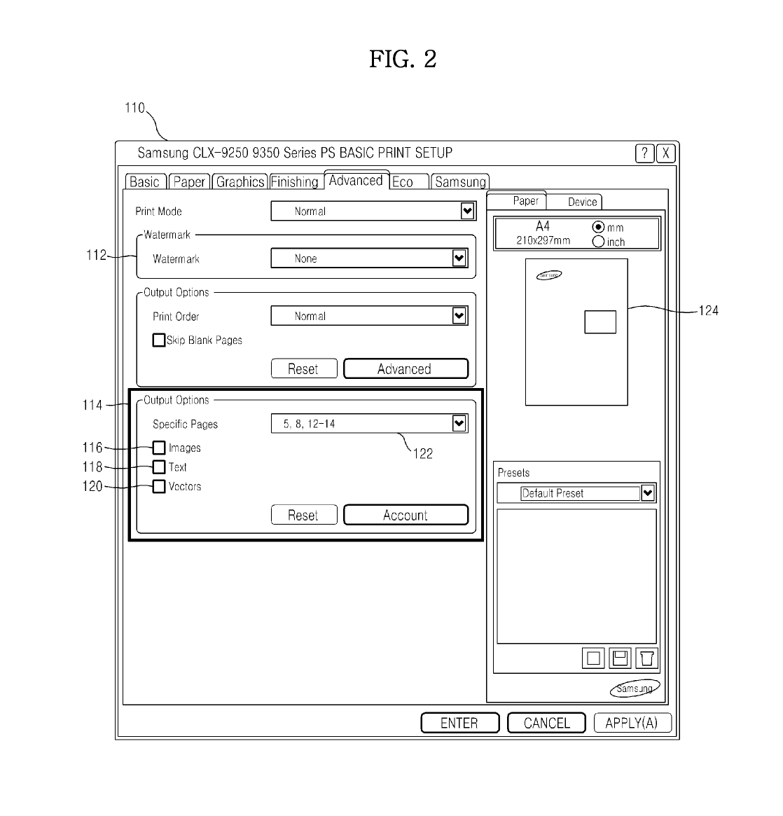

According to the print request signal input from the application program 10, the GDI 20 also calls the user interface driver 30 to provide a security preview setup screen. The security preview setup screen is provided to allow a user to select security options displayed on a preview screen. Referring to FIG. 2, the security preview setup screen 110 is provided to select security options for each object. Each object may include a vector, text, or an image which may be separately selectable with tabs 120, 118, and 116, respectively. Also, a user interface may be manipulated on the screen of FIG. 2 to select a page in area 122 and to secure the selected page. The objects and pages may be located in an output options area 114 of the security preview setup screen 110. Upon security setup of an object or a page, a substitute image may be applied, the corresponding page may be deleted, or a watermark may be applied to the corresponding page. A type of watermark or image applied to the security preview may be selected with a watermark selection area 112, and an example of a selected watermark and/or image to apply to the security preview may be illustrated by a sample image 124.

The GDI 20 temporarily spools data received from the application program 10 in the EMF spool file 40. Upon completion of spooling, the GDI 20 sends a print request to the print processor 50.

Upon reception of the print request from the GDI 20, the print processor 50 drives the previewer 70, a program to preview data. The previewer 70 may be a program stored in memory and executed by a processor to generate preview image data of the document data to be printed and to transmit the preview image data to the display 100. In addition, the previewer 70 may include one or more circuits, including a processor, memory, supporting logic, and other circuitry to communicate with a central processing unit of the printing control apparatus 1. The previewer 70 may be called through the user interface driver 30 as well as the print processor 50. The print processor 50 creates an EMF spool file 80 for preview based on the EMF spool file 40 input through the GDI 20.

The EMF is a file spooled in the memory according to a setup method of an operating system. The EMF is used as intermediate data when printing is performed in Windows.

Upon reception of a spooling end message from the Windows operating system, the print processor 50 requests the previewer 70 to start preview. The previewer 70 loads an EMF and displays the EMF on the display 100. The previewer 70 may convert the EMF into bitmap data for preview, which may be displayed on the display 100.

When a user inputs a print command through the previewer 70, the previewer 70 calls the GDI 20 such that the print graphic driver 60 is driven to perform an actual printing process.

The GDI 20 loads a rendering command from the EMF spool file 40, performs color coincidence suitable for the printer 90, and sends a print request to the printer graphic driver 60. The printer graphic driver 60 converts the print request into commands that the printer 90 interprets and sends the commands to the printer 90. The printer 90 prints data based on the commands.

In this embodiment, security is applied to the previewer file created as described above, and the file to which security is applied is output, which will be described hereinafter.

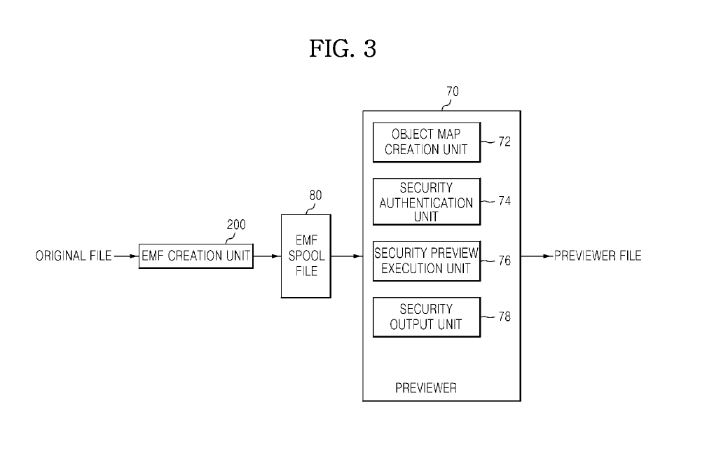

FIG. 3 is a schematic block diagram illustrating security preview and printing operations of the printing control apparatus according to the embodiment of the present general inventive concept.

For security preview, the host computer 1 includes an EMF creation unit 200, an EMF spool file 80, and a previewer 70.

The EMF creation unit 200 includes all blocks of FIG. 1 to create the EMF stored in the EMF spool file 80 for preview. For example, the EMF creation unit 200 may include the application program 10, the GDI 20, the print processor 50, and the user interface driver 30.

The EMF spool file 80 has a format defined by Microsoft at which each page is configured and stored in an EMF for each printing operation.

The previewer 70 loads an EMF from the EMF spool file 80 and displays the EMF on the display 100. The previewer 70 may convert the EMF into a bitmap file, which may be displayed on the display 100.

The previewer 70 may include an object map creation unit 71, a security authentication unit 74, a security preview execution unit 76, and a security output unit 78.

The object map creation unit 72 classifies and records an object attribute of each position of the EMF. Types of items are recorded in the EMF. Objects may be classified into the following types. The EMF includes attributes for the respective objects.

### 1. Vector Object

EMR_POLYBEZIER
EMR_POLYGON
EMR_POLYLINE
EMR_POLYBEZIERTO
EMR_POLYLINETO
EMR_POLYPOLYLINE
EMR_POLYPOLYGON
EMR_ANGLEARC
EMR_ELLIPSE
EMR_RECTANGLE
EMR_ROUNDRECT
EMR_ARC
EMR_CHORD
EMR_PIE
EMR_LINETO
EMR_ARCTO
EMR_POLYDRAW
EMR_BEGINPATH
EMR_ENDPATH
EMR_CLOSEFIGURE
EMR_FILLPATH
EMR_STROKEANDFILLPATH
EMR_STROKEPATH
EMR_FLATTENPATH
EMR_WIDENPATH
EMR_SELECTCLIPPATH
EMR_ABORTPATH
EMR_GDICOMMENT
EMR_FILLRGN
EMR_FRAMERGN
EMR_INVERTRGN
EMR_PAINTRGN
EMR_EXTSELECTCLIPRGN
EMR_POLYBEZIER16
EMR_POLYGON16
EMR_POLYLINE16
EMR_POLYBEZIERTO16
EMR_POLYLINETO16
EMR_POLYPOLYLINE16
EMR_POLYPOLYGON16
EMR_POLYDRAW16

### 2. Text Object

EMR_EXTTEXTOUTA
EMR_EXTTEXTOUTW
EMR_POLYTEXTOUTA
EMR_POLYTEXTOUTW

### 3. Image Object

EMR_BITBLT
EMR_STRETCHBLT
EMR_MASKBLT
EMR_PLGBLT
EMR_STRETCHDIBITS

Items classified into the vector, text, and image objects are resource types constituting the EMF. EMR is an enhanced meta resource, and the EMF is configured in the form of EMR_i TYPE (tag type). The classification may be changed in other embodiments.

The object map creation unit 72 records object attributes of the EMF in the manner as described above. When a user selects security options for each object, therefore, the security options may be applied to each object.

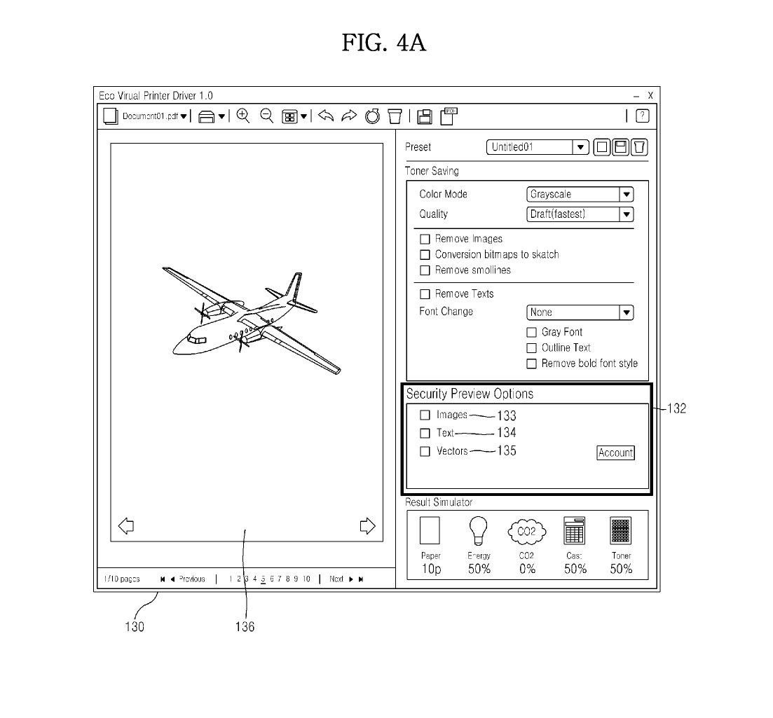

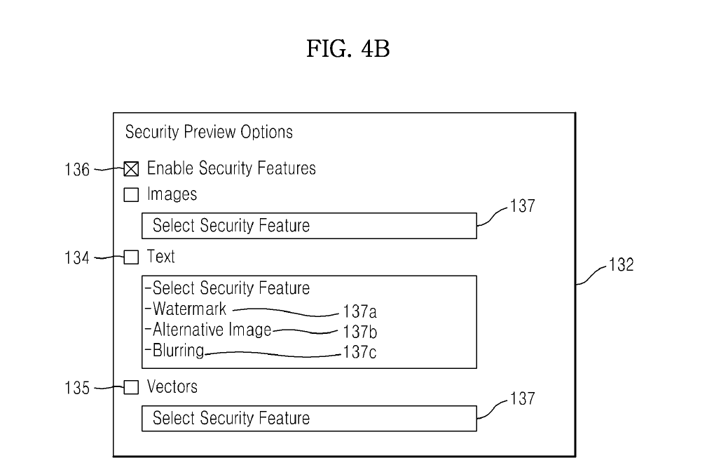

The previewer 70 may display a security preview setup screen such that preview security options are edited when a preview screen in displayed on the display 100. Referring to FIG. 4A, security preview and security output may be set when the preview screen is displayed on the display 100. Setup of security preview and security output may be performed using a method of designating a specific page, a method of designating an object attribute, a method of designating a specific area, and a method of designating a specific string.

For example, as illustrated in FIG. 4A, the preview screen 130 includes a preview image 136 and a security preview options area 132, including one or more security preview options, such as types of objects to be protected by security features, such as watermarks or alternative images. The types of objects may by indicated by boxes or other areas to indicate images 133, text 134, and vectors 135 to be protected by security feature.

As illustrated in FIG. 4B, the security preview options area 132 may include an enable box to enable security features, the object type boxes 133, 134, and 135 corresponding to images, text, and vectors of the document, and security-selection boxes or menus 137 to select a specific type of security provided for each type of object in the image. For example, the security type may be a watermark 137a, an alternative image 137b, a blurring 137c, or any other type of security feature to obstruct a view of an object in a document.

A user may previously designate and store a combination of security preview setup options and, afterward, may easily designate security preview setup as needed. For example, the following presets may be set.

Preset 1: Color image and “TOP SECRET” string (Security preview is applied to text including a color image and a “TOP SECRET” string.)

Preset 2: Text and designation of a middle area thereof (A middle area of text is designated, and security preview is applied to the designated part.)

When an ID/PW or PIN for security authentication is input to the security authentication unit 74, the security authentication unit 74 communicates with a server or performs security authentication using information stored in the host computer 1.

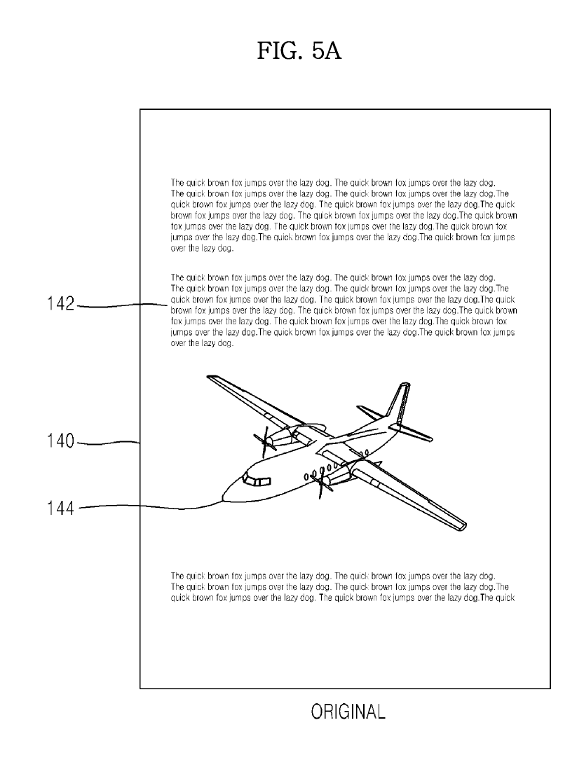

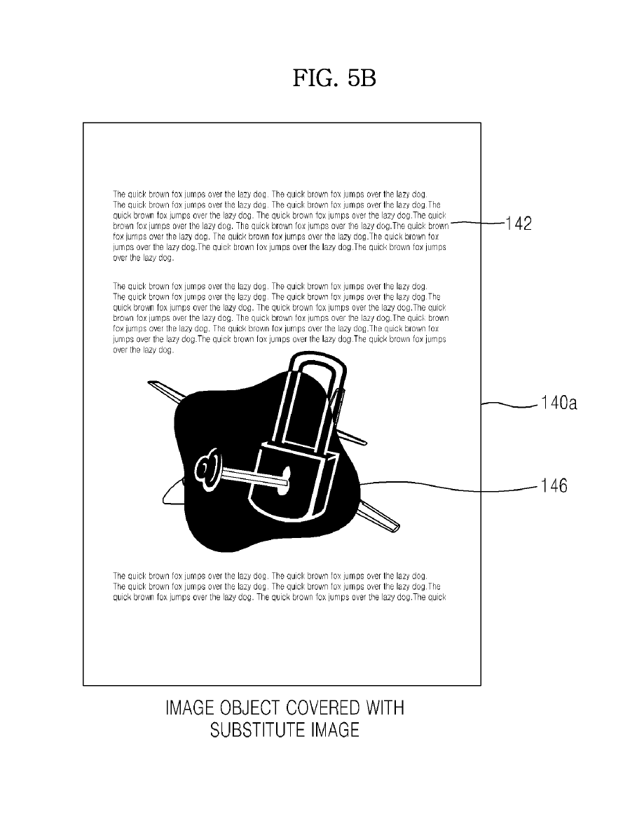

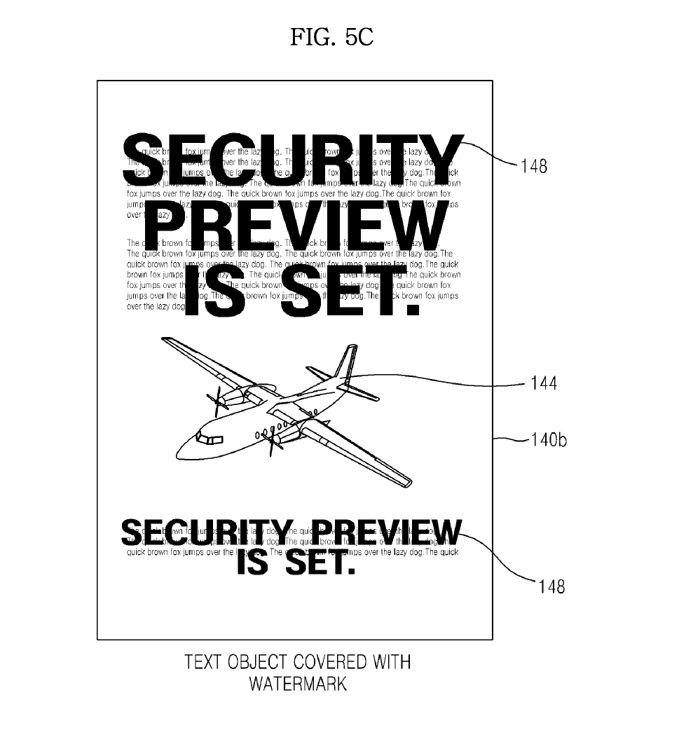

Based on information transmitted from the security authentication unit 74, the security preview execution unit 76 may display preview data to which security features are applied or preview data to which security features are not applied on the display 100. Referring to FIGS. 5A to 5C, when user security authentication for preview is not performed by the security authentication unit 74, preview data to which security features are applied are displayed (An image object is covered with a substitute image in FIG. 5B, and a text object is covered with a watermark in FIG. 5C). When the user security authentication is performed by the security authentication unit 74, preview data to which security features are not applied are displayed.

In other words, FIG. 5A illustrates a page 140 of a document including text 142 and an image 144 in which security features have not been applied. FIG. 5B illustrates the page 140a when an alternative image 146 is displayed instead of, or on top of to obstruct, the original image 144 of the page 140. FIG. 5C illustrates the page 140b when a watermark 148 is displayed instead of, or on top of, the text 142. The image 144 and the text 142 may also be hidden by blurring, by a blackout, such as black boxes, or any other security feature to obscure the view of the image or text.

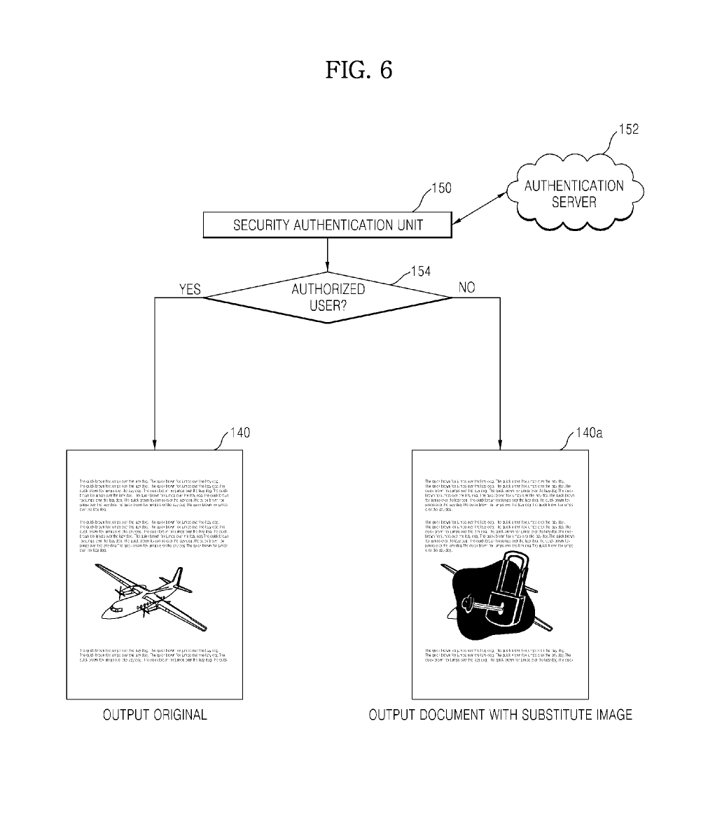

Based on information transmitted from the security authentication unit 74, the security output unit 78 may send a command to the print processor 50 to print the preview data to which security options are applied or the preview data to which security options are not applied. Referring to FIG. 6, when user security authentication for preview is not performed by the security authentication unit 74, a command to print preview data to which security options are applied is transmitted to output the preview data (the preview data is output in a state in which an original image is covered with a substitute image). When the user security authentication is performed by the security authentication unit 74, a command to print preview data to which security options are not applied is transmitted to output the preview data.

The security output unit 78 may send a command to the print processor 50 to transmit both the print preview data to which security options are applied print and the preview data to which security options are not applied to the printer 90. In this case, the printer 90 performs user security authentication. When an authenticated user requests data output, the printer 90 may output data to which security options are not applied. When an unauthenticated user requests data output, the printer 90 may output preview data to which security options are applied.

In other words, as illustrated in FIG. 6, a security authentication unit 150, which may be a host computer or a printer, for example, may prompt a user to enter security information, such as a security access code, password, or any other information. Upon receipt of the security information, the security authentication unit 150 may transmit the received information to an authentication server 152, which may be connected to the security authentication unit via a network, such as a local area network, wide area network, wired network, or wireless network. The authentication server 152 may have stored therein predetermined security information to compare to the received security information. The security authentication unit 150 may receive authentication confirmation data from the authentication server. If it is determined in operation 154 that the received security information corresponds to the security information stored in the authentication server 152, then a printing device may print the page 140 without obstructing objects on the page with security features. On the other hand, if it is determined in operation 154 that no security information has been received, or that the received security information does not correspond to the security information stored in the authentication server 152, then a printing device may print the page 140a having predetermined objects that are obstructed by security features to prevent viewing of one or more objects on the page 140a.

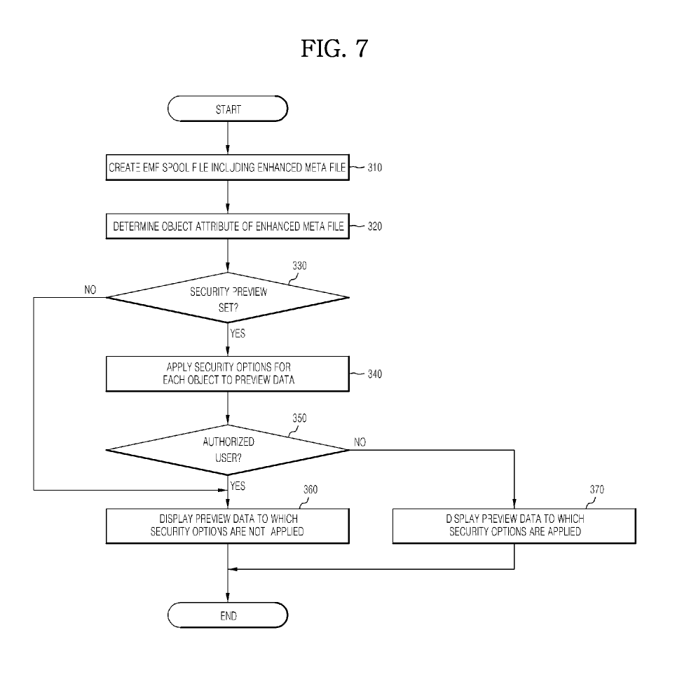

FIG. 7 is a flow chart illustrating a security preview execution method of the printing control apparatus according to the embodiment of the present general inventive concept.

When a user issues a print command through an application program, the EMF creation unit 200 creates an EMF spool file including an EMF in operation 310. The EMF creation unit 200 includes all blocks of FIG. 1 to create the EMF spool file 80 including the EMF for preview.

Subsequently, the previewer 70 loads the EMF from the EMF spool file 80 and determines and records object attributes of the EMF in operation 320. Specifically, the object map creation unit 72 of the previewer 70 classifies and records an object attribute of each position of the EMF. Types of items are recorded in the EMF. Objects may be classified based on types of items. The EMF includes attributes for the respective objects.

Subsequently, the previewer 70 determines in operation 330 whether security preview has been set. A user may manipulate the security preview setup screen through the user interface to set the security preview. The security preview setup screen is provided for the user to select security features displayed on the preview screen. The security preview setup screen is provided to select security features to apply to each object. Each object may include an image, text, or a vector. Also, the user interface may be manipulated to select a specific area of the file and secure the selected area. In other words, in the present specification and claims, security options may refer to options selectable to display or not display security features on a preview image and/or a printed image, and security features are the images (e.g. watermark, block-out, blurring, or alternative images) that are displayed in the preview image and/or the printed image.

When the security preview is set, security features are applied to the preview data in operation 340. The security features may include security setup for each object, security setup of a specific area, and security setup of a specific page. Also, when security setup is performed for a specific object, a specific area, or a specific image, various security features, such as application of a substitute image, deletion of the corresponding area, and application of a watermark to the corresponding area, may be applied.

Subsequently, the security authentication unit 74 of the previewer 70 confirms authorization information of a user in operation 350. When an ID/PW or PIN for security authentication is input to the security authentication unit 74, the security authentication unit 74 communicates with a server or performs security authentication using information stored in the host computer 1.

When user security authentication for preview is not performed by the security authentication unit 74, the security preview execution unit 76 of the previewer 70 displays, in operation 370, preview data to which security features have been applied. In other words, the predetermined objects, such as text, pictures, and graphics, may be obstructed according to the previously-set security options. When user security authentication is performed by the security authentication unit 74, the security preview execution unit 76 of the previewer 70 displays, in operation 370, preview data to which security features are not applied. In other words, the text, pictures, and/or graphics of a previewer are not obstructed by predetermined security features, such as watermarks, blocked-out portions, or replacement pictures.

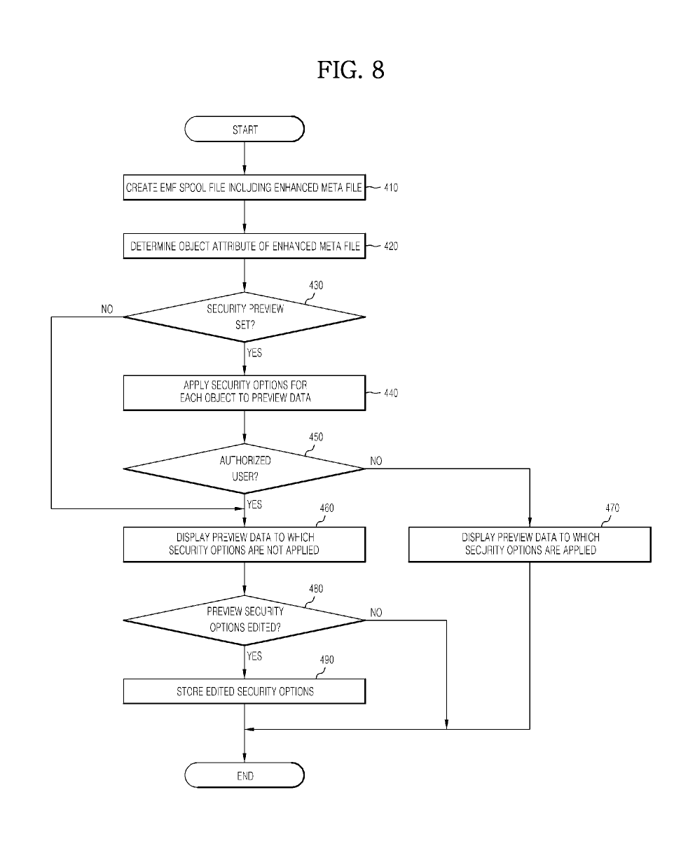

FIG. 8 is a flow chart illustrating a process of editing security options or features, during preview execution, of the printing control apparatus according to the embodiment of the present general inventive concept.

Operations 410 to 470 are identical to Operations 310 to 370 of FIG. 7, and therefore, a description thereof will not be given.

When the preview data to which the security features are not applied are displayed on the display 100 at operation 460, a user may edit preview security features. The preview security features may be edited using a method of designating a specific page, a method of designating an object attribute, a method of designating a specific area, and a method of designating a specific string. The user may previously designate and store a combination of preview security features and, afterward, may easily designate security preview setup as needed.

In operation 480, it may be determined whether the user has edited the preview security options of features. In operation 490, the edited security options may be stored.

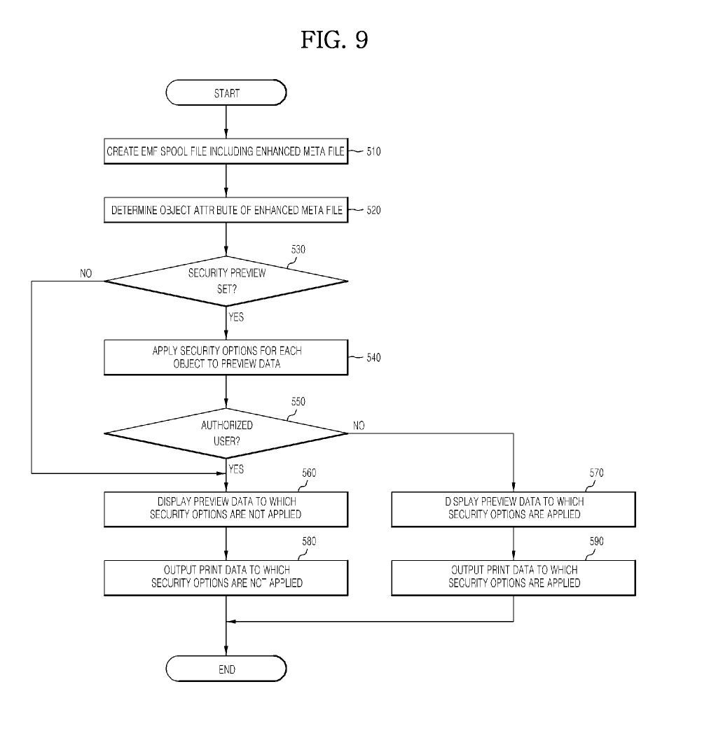

FIG. 9 is a flow chart illustrating a process of transmitting print data to the printer, after preview execution, of the printing control apparatus according to the embodiment of the present general inventive concept.

Operations 510 to 570 are identical to Operations 310 to 370 of FIG. 7, and therefore, a description thereof will not be given.

After displaying the preview data to which the security features are not applied on the display 100 at operation 560, the previewer 70 sends a command to the print processor 50 to transmit the preview data to which the security features are not applied to the printer 90, and the print processor 50 transmits print data to which the security features are not applied through the above-described procedures to the printer 90 in operation 580.

After displaying the preview data to which the security features are applied on the display 100 at operation 570, the previewer 70 sends a command to the print processor 50 to transmit the preview data to which the security features are applied to the printer 90, and the print processor 50 transmits print data to which the security features are applied through the above-described procedures to the printer 90 in operation 590.

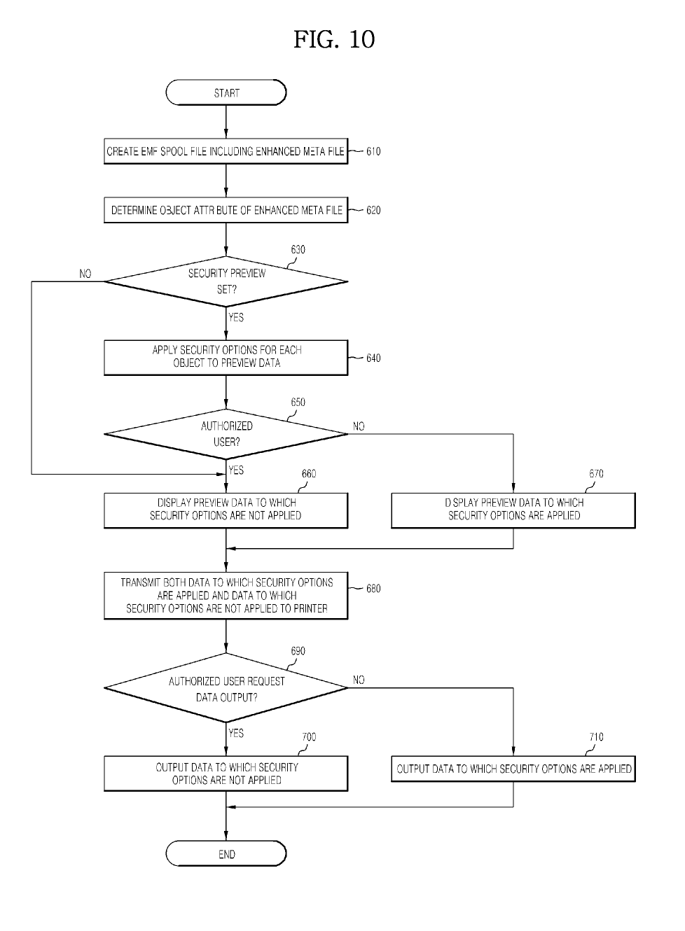

FIG. 10 is a flow chart illustrating a process of transmitting print data to a printer, after preview execution, of the printing control apparatus according to the embodiment of the present general inventive concept.

Operations 610 to 670 are identical to Operations 310 to 370 of FIG. 7, and therefore, a description thereof will not be given.

The embodiment of FIG. 10 is different form the embodiment of FIG. 9 in that both print data to which security features are applied and print data to which security features are not applied are transmitted to the printer 90 irrespective of whether security preview setup is performed, the printer performs user authentication to output the print data to which the security features are not applied when an authenticated user requests output of the print data and output of the print data to which the security features are applied when an unauthenticated user requests output of the print data.

At operation 680, both print data to which security features are applied and print data to which security features are not applied are transmitted to the printer 90.

Subsequently, the printer 90 performs security authentication to output the print data to which the security features are not applied when an authenticated user requests output of the print data and to output the print data to which the security features are applied when an unauthenticated user requests output of the print data in operations 690 to 710.

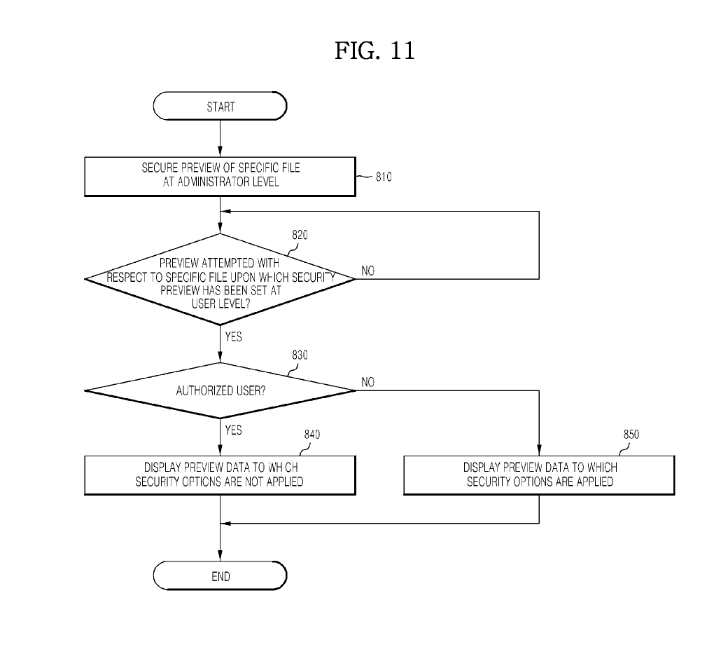

FIG. 11 is a flow chart illustrating an administrator level and display of preview data based on the administrator level, during preview execution, of the printing control apparatus according to the embodiment of the present general inventive concept.

An administrator may access security preview setup features at an administrator level to secure preview features for each object. The administrator level is a level at which an authenticated administrator sets up security preview features in operation 810.

Subsequently, it is determined in operation 820 that preview is attempted with respect to a specific file upon which security preview features have been set at a user level. This is because, when the administrator sets up security preview setup features at operation 810, security authentication is additionally performed at the user level to maintain document security. The user level may be a level at which preview data may not be edited even in the case of security authentication or a level at which preview data may be edited in the case of security authentication.

When preview is attempted with respect to a specific file, security preview features of which have been set, at the user level, it is determined whether the user is authorized in operation 830.

When it is determined at Operation 820 that the user attempting the preview is authorized, preview data to which security features are not applied are displayed, and, when it is determined that the user attempting the preview is unauthorized, preview data to which security features are applied are displayed in operations 840 and 850.

Meanwhile, the preview data of FIGS. 7 to 11 may be an EMF spool file or a bitmap file converted from an EMF spool file.

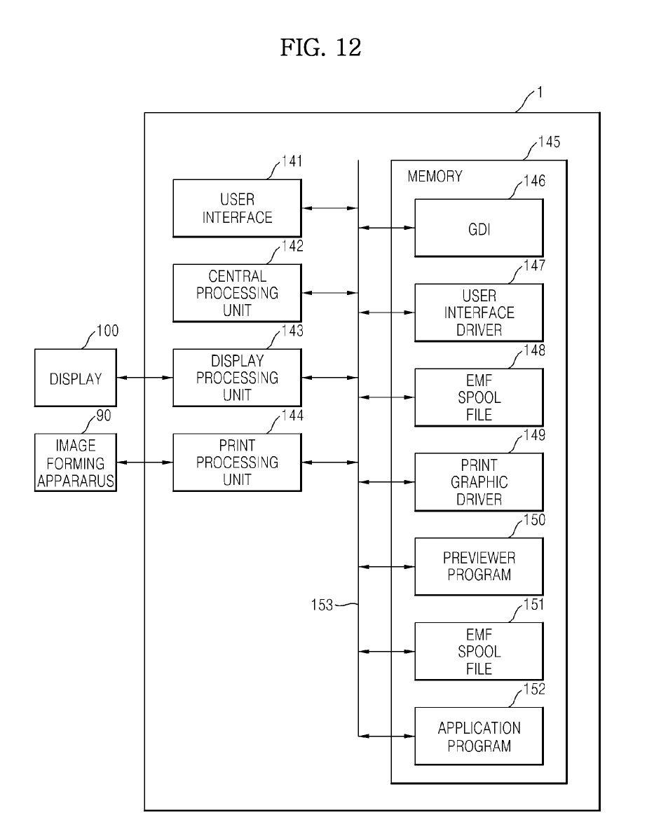

FIG. 12 illustrates an example of a printing control apparatus 1 according to an embodiment of the present general inventive concept. The printing control apparatus 1 may include a user interface 141, such as a keyboard, keypad, touch-pad, mouse, or other input to receive an input from a user to control a printing operation. A central processing unit 142 may control general operations of the printing control apparatus 1, such as detecting inputs and controlling outputs. The display processing unit 143 may include one or more processors, memory, and logic units to receive data and to convert the data to display data to be displayed on a display 100, such as a screen, monitor, or other display device. The print processing unit 144 may include one or more processors, memory, and logic devices to receive data and to convert the data to print data to be printed by an image forming apparatus 90 connected to the printing control apparatus 1. The central processing unit 142 may control operation of the display processing unit 143 and the print processing unit 144, such as determining which data is input to the respective processing units and to where the data is transmitted from the respective processing units.

Each of the processing units 142, 143, and 144 may be separate processing units, or they may be part of one processing unit. For example, the central processing unit 142 may control all of the functions of display processing and print data processing using predetermined programs stored in memory.

The printing control apparatus 1 may also include memory 145 to store programs, applications, and data. The memory 145 may include ROM, RAM, hard disks, or any other type of memory. Although various programs are illustrated in FIG. 12 as being stored in memory 145, some of the programs may be stored in ROM (e.g. the user interface driver 147) and some may be stored in RAM (e.g. the EMF spool files 148 and 151). The graphics device interface 146, user interface driver 147, print graphic driver 149, previewer program 150, and application program 152 may all be programs stored in memory to be accessed by the processing units 142, 143, and 144 to perform print functions, and may correspond to the GDI 20, user interface driver 30, print graphic driver 60, previewer 70, and application program 10 of FIG. 1. Similarly, the EMF spool files 148 and 151 may include data stored in memory and may correspond to the EMF spool files 40 and 80 of FIG. 1.

While the graphics device interface 146, user interface driver 147, print graphic driver 149, previewer program 150, and application program 152 are illustrated as being programs in FIG. 12, each may also correspond to physical circuitry, such as a processor, memory, and logic circuitry. For example, a previewer 70, as illustrated in FIG. 1 may include the print processor 50, memory, and supporting logic, and the print processor 50 may access code from the memory to generate a print preview including the security preview, as described above in FIGS. 4A and 4B.

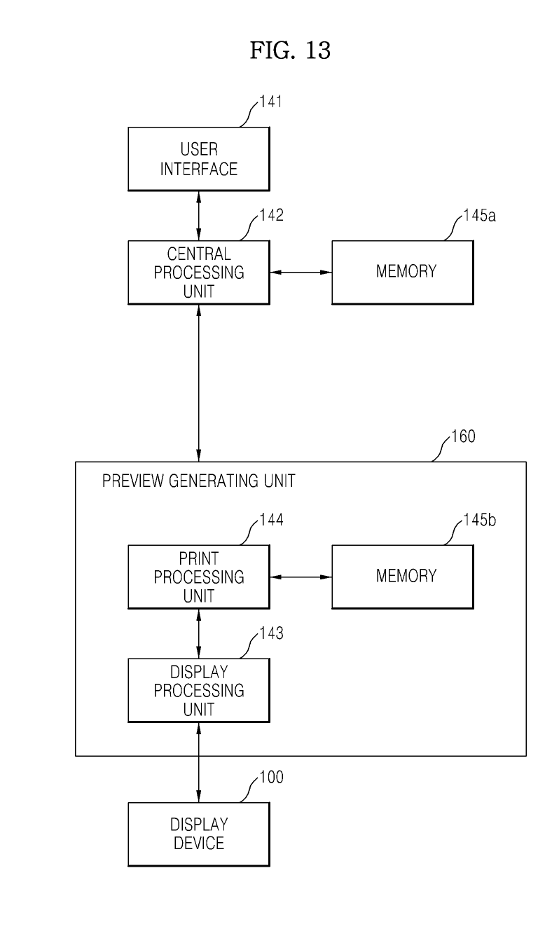

FIG. 13 illustrates a preview generating unit 160 that may correspond to the previewer 70 of FIG. 1, for example. The preview generating unit 160 includes a print processing unit 144, a display processing unit 143, and memory 145b. The print processing unit 144 and the display processing unit 143 may be the same processing unit or may be separate processing units, including processors and supporting logic, to perform separate display and print functions.

The preview generating unit 160 receives image data and a print request from a central processing unit (CPU) 142. The CPU 142 may generate the print request in response from an input from a user via the user interface 141. The user may generate the input based on displayed information from an application stored in memory 145a and executed by the CPU 142, for example.

Upon receiving from the CPU 142 the print request, the preview generating unit 160 may generate display data corresponding to a preview, which may include security data, and may output the image data to a display device 100. The process of generating the preview has been described above with respect to FIGS. 1-12, and will not be repeated here.

The structure of the preview generating unit 160 is provided as an example, but the present general inventive concept is not limited to the specific structure of FIG. 13. For example, the preview generating unit 160 may include additional devices, chips, or operating units. The processors 143 and 144 may be dedicated to the preview generating unit or they may be used by other functional units of a printing control apparatus 1. For example, the print processing unit 144 may be used in each print operation, including those in which preview images are not generated. Similarly, the display processing device 143 may be used in display operations of a printing control apparatus that do not include generating a preview image.

Similarly, the memory 145b may be one or more chips dedicated to the preview generating unit 160, or the memory 145b may include predetermined areas within general purpose memory chips that are dedicated to generating preview images. The dedicated areas may be temporarily dedicated, so that the size of the dedicated area changes according to the size of the preview images to be stored and displayed, or the dedicated areas may be predetermined so that other functions of the printing control apparatus 1 may not access the dedicated areas, even when the preview generating unit 160 is not in operation.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can generate or transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, a preview screen upon which security features for each object is set is displayed, thereby preventing malicious use and easily achieving security intended by a user.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A printing control apparatus with a document security function, comprising:
a user interface driver to provide a security preview setup screen such that security preview options for each object are selected when a call signal is transmitted from a graphic device interface according to a print request signal input from an application program; and
a previewer to divide objects through the security preview setup screen and to secure a corresponding one of the objects when the security preview options are set so as to perform preview.

2. The printing control apparatus according to claim 1, wherein the previewer comprises an object map creation unit to record and store an object attribute of each position of an enhanced meta file converted from an original file such that preview is performed before printing.

3. The printing control apparatus according to claim 2, wherein the previewer further comprises a security preview execution unit to confirm the object attribute of each position of the enhanced meta file recorded by the object map creation unit when a security operation is set to be performed with respect to one or more of the objects through the security preview setup screen and to secure and display the object to which the security operation is set to be performed.

4. The printing control apparatus according to claim 2, wherein the previewer further comprises a security authentication unit to communicate with a server or perform security authentication using information stored in a host computer upon reception of an ID/PW or PIN for the security authentication.

5. The printing control apparatus according to claim 4, wherein the previewer further comprises a security output unit to create and send a command to print data to which security options are applied to a print processor or to create and send a command to print data to which security options are not applied to the print processor according to security authentication information transmitted from the security authentication unit.

6. The printing control apparatus according to claim 1, wherein the previewer simultaneously displays the security preview setup screen and a preview screen such that preview security options are edited during execution of the preview.

7. The printing control apparatus according to claim 1, wherein each of the objects comprises at least one selected from a group consisting of text, a vector, and an image.

8. A control method of a printing control apparatus with a document security function, comprising:
converting an original file into an enhanced meta file to perform preview before printing and spooling the enhanced meta file;
loading the spooled enhanced meta file to classify and record an object attribute of each position of the enhanced meta file;
converting the enhanced meta file into preview data that are displayed on a display; and
determining whether security preview options for each object have been selected upon execution of the preview and securing the corresponding objects to perform preview upon determining that the security preview options for each object have been selected.

9. The control method according to claim 8, further comprising:
performing security authentication of a user requesting the preview; and
performing security preview upon which a security operation is performed or general preview upon which a security operation is not performed according to a result of the security authentication.

10. The control method according to claim 9, further comprising transmitting preview data upon which the security operation has been performed or preview data upon which the security operation has not been performed to a printer according to a result of the security authentication.

11. The control method according to claim 9, further comprising transmitting preview data upon which the security operation has been performed or preview data upon which the security operation has not been performed to a printer connected to the printing control apparatus such that the printer performs security authentication to output a document.

12. The control method according to claim 9, wherein performing security authentication of the user requesting the preview comprises communicating with a server or performing security authentication using information stored in a host computer upon reception of an ID/PW or PIN for the security authentication.

13. The control method according to claim 8, wherein classifying and recording the object attribute of each position of the enhanced meta file comprises classifying and recording object attributes based on types of items recorded in the enhanced meta file.

14. A printing control apparatus, comprising:
a previewer to determine whether a security option has been set to obstruct at least one type of object in a preview image, and to generate the preview image including a security feature to obstruct the at least one type of object when it is determined that the security option has been set.

15. The printing control apparatus of claim 14, wherein the previewer determines whether the security option has been set with respect to each separate one of at least text, graphics, and pictures of a document to be previewed.

16. The printing control apparatus of claim 14, wherein the security feature includes at least one of a watermark, a blackout block, a replacement image, and a blurring effect.

17. The printing control apparatus of claim 14, further comprising a security authentication unit to determine whether predetermined authentication information has been received, to generate the preview image including the security feature when it is determined that the predetermined authentication information has not been received, and to generate the preview image to exclude the security feature when it is determined that the predetermined authentication information has been received.

18. The printing control apparatus of claim 14,
wherein the previewer comprises:
a print processing unit to receive image data and an initial print command and to generate preview image data; and
a display processing unit to receive the preview image data and to generate display data based on the preview image data to transmit to a display device to display the display data.

19. The printing control apparatus of claim 18, wherein the print processing unit generates an EMF spool file and loads the EMF spool file to generate the preview image data.

20. A method of securely providing data in a printing apparatus, the method comprising:
receiving print data corresponding to a request to print data;
determining whether a security option has been set to obstruct at least one type of object in a preview image corresponding to print data to be printed; and
generating the preview image including a security feature to obstruct the at least one type of object when it is determined that the security option has been set.

21. The method of claim 20, wherein the request to print data is received from an application running on a computing apparatus, and the print data corresponds to a document generated by the application.

22. The printing control apparatus of claim 20, wherein determining whether the security option has been set includes determining whether the security option has been set with respect to each separate one of at least text, graphics, and pictures of a document to be previewed.

23. The printing control apparatus of claim 20, wherein the security feature includes at least one of a watermark, a blackout block, a replacement image, and a blurring effect.

24. The printing control apparatus of claim 20, wherein determining whether a security option has been set includes determining whether predetermined authentication information has been received, and
generating the preview image including the security feature when it is determined that the predetermined authentication information has not been received, and generating the preview image to exclude the security feature when it is determined that the predetermined authentication information has been received.

25. A computer-readable medium having stored thereon a code to execute a method, the method comprising:
receiving print data corresponding to a request to print data;
determining whether a security option has been set to obstruct at least one type of object in a preview image corresponding to print data to be printed; and
generating the preview image including a security feature to obstruct the at least one type of object when it is determined that the security option has been set.
